(19) United States
(12) Patent Application Publication
(10) Pub. No.: US 2005/0215744 A1
(43) Pub. Date: Sep. 29, 2005

(54) Combination of a material and a bath fluid for use in rapid prototyping methods

(75) Inventors: Hinrich Wiese, Kaufbeuren (DE); Gerhard Maier, Munchen (DE)

Correspondence Address: EDWARDS & ANGELL, LLP, P.O. BOX 55874, BOSTON, MA, 02205, US

(73) Assignee: PolyMaterials AG, Kaufbeuren (DE)

(21) Appl. No.: 10/519,894

(22) PCT Filed: Jun. 27, 2003
(86) PCT No.: PCT/EP03/06858

§ 371 Date: Dec. 28, 2004

(30) Foreign Application Priority Data
Jun. 28, 2002 (DE) 102 29 124.1

(51) Int. Cl. C08F 118/02

(52) U.S. Cl. 526/319

(57) ABSTRACT

The present invention relates to combinations of a building material and a bath fluid for methods for directly printing visual-aid models or elements, in particular, for the use in the office or at home. Furthermore, the present invention relates to the polymers obtained by the reaction of the building material and the bath fluid and to elements or models produced from the combinations according to the present invention. The use of the combinations according to the present invention in rapid prototyping methods enables the production of elements having varying mechanical properties. Coloured elements can be obtained by adding colourants. The elements made from the building materials according to the present invention exhibit mechanical properties, a thermostability and accuracy in every detail, thus rendering them suitable as visual-aid models and discussion models for design, architectural, constructional and other blueprints. The surface quality, the rigidity and the hardness of the elements can be improved by post-treatment.

The present invention relates to combinations of a building material and a bath fluid for methods for directly printing visual-aid models or elements, in particular, for the use in the office or at home. The invention further relates to polymers obtained from the reaction of the building material and the bath fluid and to the elements and models produced from the combinations according to the present invention. The use of the combinations according to the present invention in rapid prototyping methods enables the production of elements having varying mechanical properties. Coloured elements can be obtained by adding colourants. The elements made of the building materials according to the present invention exhibit mechanical properties, a thermostability and accuracy in every detail, thereby rendering them suitable as visual-aid models and discussion models for design, architectural, constructional and other blueprints. The surface quality, the rigidity and the hardness of the elements can be improved by post-treatment.

Various methods for producing three-dimensional objects having an arbitrary shape on the basis of data files (e.g., CAD) such as as a discussion model, a visual-aid model, a design model or a functional model are known under the term “rapid prototyping”. The three-dimensional objects are formed layer by layer in most of these methods.

The following methods are of particular importance:
Stereolithography (SLA) (photopolymers are cured by irradiation with a suitable laser): Elements are obtained with a high resolution and mechanical properties, which are comparable to those of technical plastics. However, the costs of the method (laser) and the sources of danger (toxic educts and use of the laser) are detrimental.
Selective Laser Sintering (SLS) (metals, plastics or ceramics; in the case of ceramics, a powder is fused layer by layer by means of a laser): Using particularly suitable materials, the elements achieve approximately the same stability as elements of the same material obtained by injection molding. However, the handling of the powder (typical particle sizes from 20 to 50 μm) requires considerable efforts in order to avoid contamination of the environment with the powder.
3-D-Printing (3DP) (a powder is formed into three-dimensional objects using liquid binders). The method is rapid, however, it leads to elements having a moderate resolution and frequently unsatisfying mechanical properties. However, these properties can optionally be improved by a post-treatment step.
Fused Deposition Molding (FDM) (melts of waxes or low melting thermoplasts are deposited in strands or droplets to yield the desired molded articles and, subsequently, they solidify). For example, thermoplasts (such as polyamide or acrylonitrile-butadiene-styrene-copolymers) can be employed. However, the resolution and the accuracy in every detail, respectively, are inferior.

A novel method requiring a relatively simple setup and thus being also suitable for use in the office or at home that does not require specific training of the users is described in WO 01/26885, claiming priority of DE 19948591 A1. It is based on the use of a liquid building material having a low viscosity that is deposited in a computer-controlled way onto specific positions on a building support by means of a drop-on-demand technique (comparable to an ink jet), and that thereby solidifies in a physical or chemical process. By depositing the building material layer by layer, a three-dimensional object having arbitrary shape is formed step by step. In this method, the building support is positioned in a bath. The bath fluid serves to fill the areas that are not filled by the building material and to act as a supporting material in the formation of overhanging structures.

Suitable materials are not described in WO 01/26885 in more detail. It is merely mentioned that thermoplastic or waxy materials having a viscosity of not more than 20 mPa·s at a temperature of not more than 130° C. can be employed, which cool down during deposition and, thus, solidify. Furthermore, it is mentioned that the solidification can also be caused by a chemical reaction by contacting an ingredient of the bath fluid or by thermically initiated crosslinking.

Building materials such as the waxes mentioned in WO 01/26885 that solidify solely by cooling down from the processing temperature (according to the method described in WO 01/26885 130° C. at the most) to room temperature and, nevertheless, have the very low viscosity required for processing, exhibit an insufficient thermostability. Their softening already occurs at temperatures slightly above room temperature. As a result, they cannot serve as models to be touched. Furthermore, functional models cannot be produced using these materials because their mechanical properties are insufficient.

The description in WO 01/26885 does not disclose the composition of suitable building materials fulfilling the requirement of having a low viscosity at the processing temperature, which can be solidified by a chemical reaction or by thermal crosslinking and, subsequently, have a sufficient thermostability and good mechanical properties.

The successful application of the method described in WO 01/26885 poses very high demands on building material, bath and the combination thereof. Running systems of this kind are not known. The demands on such systems are as follows: The solidification has to proceed in a sufficiently rapid way in order to achieve a sufficient resolution of the structures produced, because flowing of the building material reduces the resolution due to a too slow curing. However, the curing has to proceed at the same time slowly enough in order to ensure an adhesion or a sticking of the droplets among each other and between subsequent layers. Moreover, it has to be ensured that the building material does not solidify until it contacts the bath fluid and not already in the outlet ports of the deposition device or in storage containers. For the application in the office or at home, when operated by untrained persons it is further required that the components, in particular the bath fluid are not toxic and the disposal of the bath fluid by way of the regular canalisation is possible without further action. Thus, for example the use of most of the known, technically employed monomers and initiators for the formation of polymers or for crosslinking, are practically excluded as ingredients of the bath fluid. The demands on the mechanical rigidity of the three-dimensional elements produced also excludes materials that result in powdery crystalline products after solidification (e.g., solutions of low molecular or polymeric substances, which precipitate on contact with the bath fluid). In most cases waxy materials exhibit a too low thermostability. It is possible to produce three-dimensional molded elements according to the method described in WO 01/26885 using particular waxes. However, these elements already soften due to the body temperature upon contact with the hand.

Therefore, there is the problem in applying the method described in WO 01/26885 for the production of three-dimensional elements, that there are presently no known suitable building materials and bath fluids, which result in elements having a sufficiently high thermostability and mechanical stability.

Also WO 01/78968 discloses the formation of solid or semi-solid objects by applying droplets or strands layer by layer onto a support positioned in a bath fluid. However, the method described therein requires that the outlet port of the dosing device is under the surface of the bath fluid. The materials described therein (oligomers or polymers, which are liquid at room temperature, melts of oligomers or polymers, reactive oligomers or polymers, gels, pastes among others) exhibit either too high a viscosity for dosing, e.g., using an ordinary ink jet print head, or similar limitations as those for WO 01/26885 apply. That is, also WO 01/78968 does not give any hints how to prevent that a reactive material immediately hardens when being dosed into the bath fluid and, thus, plugs the dosing device. Particularly, in those cases, wherein a building material essentially consisting of a liquid-monomer is used in combination with an aqueous bath fluid, there is the problem that it cannot be avoided that a liquid monomer arbitrarily flows within the bath after dosing, when the method described in WO 01/78968 is applied using a dosage device having a port under the bath surface. Moreover, only very few monomers can be processed using water as a bath liquid, because their density has to be higher than 1 g/cm³ in order to avoid floating of the liquid monomer. These problems can only be solved, if the liquid monomer polymerises very rapidly, resulting in the problem that it already polymerises in the outlet port of the dosing device as well, thereby plugging it. In this context, the use of retarding substances (claims 21 to 23 of WO 01/78968) described in WO 01/78968 is counter-productive. Therefore, the materials described in WO 01/78968 cannot be used in the method described in WO 01/26885.

Therefore, it is the object underlying the present invention to provide suitable low-viscosity building materials and bath compositions for the production of three-dimensional models or elements by means of a method, preferably by means of the method described in WO 01/26885, wherein the building material is deposited in a computer-controlled way onto specific positions of a support layer by layer in form of single droplets, where it is chemically solidified in these positions in the presence of a bath fluid, the outlet port of the dosing device being located above the surface of the bath fluid in order to avoid plugging of the outlet port.

The building materials and the bath compositions shall be cost-efficient and shall not contain any toxic compounds. Moreover, their handling shall be easy in order to enable their use in the office or at home by a user without a specific training.

The cured building material, i.e., the three-dimensional models obtained, shall have a good thermostability and further favourable mechanical and other physical properties so that models which can be touched and functional models can be obtained. Finally, the three-dimensional models obtained shall exhibit a good accuracy in every detail. In certain embodiments the elements shall also be suitable as scaffolds in tissue engineering.

In principle, this object can be solved by using a combination of a building material and a bath fluid, the building material (“ink”) containing low-viscosity, low-molecular compounds capable of rapidly forming polymers having sufficient mechanical properties, when contacted with the bath fluid. This can be carried out either by polymerizing one or more monomers contained in the building material upon contact with the bath fluid or by forming a branched or crosslinked polymer by reacting one or more low-viscosity multifunctional compounds contained in the building material with oligomeric or polymeric compounds contained in the bath fluid.

Thereby, the deposition of the building material (“ink”) is carried out by means of a suitable dosing device, such as an ink jet print head, droplet by droplet into the bath fluid, that is, in layers corresponding to subsequent cross sections of the desired element. Thereby, the first layer is deposited onto a building platform or another suitable support. Then each of the following layers can be applied onto the preceding layer or onto the bath surface depending on the shape of the desired element. A three-dimensional element is obtained by the sequence of an adequate number of layers.

The droplets are produced by a dosing system capable of producing single droplets or flows of droplets having a diameter in the range of 20 to 200 μm, preferably 50 to 90 μm and depositing these droplets at a predetermined position, for example, according to the principle of an ink jet print head. The building material must preferably have a viscosity of less than 200 mPa·s, particularly preferred less than 30 mPa·s in the processing state and further a suitable surface tension compared to the bath fluid for an accurate dosing. Furthermore, the building material must polymerise rapidly after deposition. Thereby, a good connection of the droplets among each other and to the building material of the preceding layer has to be achieved. At the same time it has to be ensured that the building material does not prematurely solidify in the storage container, in the dosing device, in the respective connections, in the die nor in another outlet port.

In the case of monomer-based building materials, this can be achieved for example by incorporating into the bath fluid an initiator or a catalyst initiating the polymerisation of the monomers or the monomer mixture in the droplet of the building material. Alternatively, the building material itself can contain an initiator or a catalyst and, additionally, an inhibitor or a stabilizer, the inhibitor or the stabilizer being selected such that it can be deactivated by a compound contained in the bath. Furthermore, the initiator or catalyst system can also consist of several components, one or more of which are contained in the bath and the others are contained in the building material. In this case, the polymerisation is initiated upon contact between the building material and the bath at the time when all components get into contact. Moreover, for building materials on the basis of crosslinking agents a defined start of the reaction can be ensured by selecting the multifunctional compounds in the building material such that these compounds are able to react only with multifunctional oligomers or polymers contained in the bath, and not with each other.

The terms “initiator”, “catalyst”, “stabilizer” and “inhibitor” are used herein according to the definitions used in the literature in the field of polymer chemistry.

According to the present invention a combination of at least one building material and a bath fluid for a method for directly printing elements and models is provided, characterized in that
A) the building material contains at least one low-viscosity monomeric or oligomeric compound having a viscosity <200 mPa·s which polymerises in contact with the bath fluid by polymerisation of at least one component and
   the bath fluid consists of an aqueous solution containing an initiator, which initiates the polymerisation of at least one component of the building material or
B) the building material contains at least one low-viscosity multifunctional compound having a viscosity <200 mPa·s as a crosslinking agent and
   the bath fluid contains oligomeric or polymeric compounds forming a branched-chain or crosslinked polymer by a reaction with the building material.

In this connection, the term “low viscosity” denotes a viscosity lower than about 200 mPa·s, preferably lower than about 30 mPa·s at room temperature.

As used herein “multifunctional compounds” are compounds having at least two reactive functional groups, the functional groups being for example isocyanate, carboxylic acid, sulfonic acid, carboxylic acid chloride, sulfonic acid chloride, carboxylic acid anhydride, epoxide, alkoxy silane, chlorosilane, acetoxysilane, amine, alcohol, thiol, acrylic groups or other groups known in the field of organic and inorganic chemistry, which are suitable for the formation of polymers or for chemical or physical crosslinking.

A preferred combination of a building material and a bath fluid according to the present invention comprises as a building material a cyanoacrylate, a mixture of cyanoacrylates or a mixture of one or more cyanoacrylate(s) with additional anionically polymerisable compounds, the building material containing an acidic stabilizer inhibiting the premature polymerisation. Thereby, a basic aqueous solution is used as a bath fluid.

Cyanoacrylates represented by the general formula 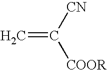
are preferred ingredients of the building material. The residue R comprises linear or branched, monosubstituted or polysubstituted or unsubstituted, aliphatic, cycloaliphatic or olefinic groups having 1 to 10 carbon atoms, such as methyl, ethyl, propyl, butyl, pentyl, and hexyl, cyclopentyl, cyclohexyl, vinyl, propenyl and butenyl groups,
monosubstituted or polysubstituted or unsubstituted aromatic groups having 6-18 carbon atoms, such as phenyl, naphthyl, anthranyl, biphenyl and triphenyl groups, saturated, unsaturated or aromatic 3- to 7-membered heterocyclic groups having one or more heteroatom(s), which are independently selected from N, S, O and P and which may be substituted with one or more substituents(s),
the substituents(s) of the above residues R being selected from halogen (F, Cl, Br, I), hydroxyl, oxo, cyano, C₁₋₈-alkoxy, amino, mono or di(C₁₋₈)alkylamino, nitro, mercapto and —S(O)ₙ(C₁₋₈)-alkyl (n=0, 1, 2).

According to the present invention, methyl cyanoacrylate, ethyl cyanoacrylate, butyl cyanoacrylate and 2-methoxyethyl cyanoacrylate are preferred. Primarily in view of their use in the office, ethyl cyanoacrylate and 2-methoxyethyl cyanoacrylate are particularly preferred. The use of building materials on the basis of cyanoacrylates has the advantage that commercially available solvents for cyanoacrylate adhesives (“super glue”) can be used for cleaning the dosing device and the print head, respectively. As materials for the storage containers for the building material the same materials as for containers for cyanoacrylate adhesives can be employed.

The initiation of the polymerisation during the deposition occurs at the surface of the individual droplets by contact of the cyanoacrylate monomer(s) with the aqueous bath fluid, the acidic stabilizer being neutralized by the base contained in the bath fluid, thereby losing its efficiency. Thus, the polymerisation is initiated. Thereby, the additional comonomers, which are optionally present, are copolymerised to a greater or lesser extent corresponding to their copolymerisation behaviour.

Surprisingly, the formation of high molecular polymers is achieved using the combination of the cyanoacrylate containing building material and a basic aqueous bath fluid according to the present invention despite the excess of water used as an initiator because due to the dropwise introduction of the building material into the bath fluid, the low solubility of water in the building material and the high rate, with which the droplets of the building materials solidify, the contact of the monomers with the bath fluid takes place only for a short period and only at the surface of the droplets. Thus, only a relatively small number of water molecules or hydroxy ions can initiate the polymerisation of the cyanoacrylate. Since the polymerisation starts at the surface of the droplets, the polymer is formed there, preventing the permeation of additional water to such an extent that the droplets are able to gradually polymerise from the outside to the inside.

According to the present invention, the reduction of the molecular weight of polycyanoacrylates in the presence of water, which has been described in the literature (D. R. Robello, T. D. Eldridge, M. T. Swanson, J. Polym. Sci, Part A, 1999, 37, 4570-4581), can be achieved by using suitable comonomers together with cyanoacrylate monomers in the building material, although the polymerisation proceeds due to the contact with a basic aqueous bath according to an anionic mechanism. This is in contrast to the state of the art, according to which this is only possible, if the polymerisation proceeds according to a radical mechanism.

In this regard, particularly suitable comonomers are cyclic comonomers, in particular, lactides, i.e., cyclic diesters of α-hydroxy carboxylic acids such as 3,6-dimethyl-1,4-dioxane-2,5-dione (the “lactide”), or cyclic anhydrides such as maleic anhydride or epoxides, particularly glycidyl compounds such as glycidyl methacrylate and butandiol diglycidyl ether. The lactides are present in an amount of 1 to 25% by weight, preferably 5 to 20% by weight, the cyclic anhydrides are present in an amount of 1 to 25% by weight, preferably 2 to 10% by weight, and the epoxides are present in an amount of 0.1 to 5% by weight, preferably 0.5 to 3% by weight, based on the total formulation, respectively. The polymers produced therefrom do not exhibit a change in colour or a substantial loss in mechanical properties and in molecular weight even after a longer residence time in basic aqueous liquids. Thus, they exhibit an improved stability against hydrolysis compared to polycyanoacrylates without these comonomers. This is of particular importance for the present invention, because, depending on their size, the elements optionally remain in the basic aqueous bath fluid for a longer period during the building procedure. The increased stability of polycyanoacrylates achieved by lactide is illustrated by the polyethylcyanoacrylate of Example 7. The improvement of mechanical properties achieved by glycidyl compounds can be seen from Example 8.

In addition to the monomers further additives can be contained in the building material in order to adapt the properties. In this connection, stabilizers, surface-active substances (tensides, soaps, amphiphilic oligomers and polymers), dyes and solvents should be particularly emphasized.

In the preferred embodiment of the building material an acidic stabilizer is contained besides a cyanoacrylate or a mixture of cyanoacrylates and/or further comonomers. The term “acidic stabilizers” concerns both Bronsted acids and Lewis acids as well as compounds producing acidic compounds upon contact with air humidity or water. The stabilizers have to exhibit a sufficiently low volatility in order to ensure a sufficient stability also in the presence of air or air moisture. Gases such as sulfur dioxide or hydrogen chloride, organic acids such as carboxylic acids (e.g., formic acid, acetic acid, benzoic acid and other carboxylic acids known in the field of organic chemistry) or sulfonic acids (e.g., methane sulfonic acid, ethane sulfonic acid, trifluoromethane sulfonic acid, toluene sulfonic acid and other sulfonic acids known in the field of organic chemistry) or organic phosphonic acids (e.g., vinyl phosphonic acid) can be employed. Preferred stabilizers are sulfonic acids with ethane sulfonic acid being particularly preferred.

In the preferred embodiment the building material contains a surface-active compound such as the sodium salt of lauryl sulfonic acid, dodecyl dimethyl (3-sulfopropyl)ammonium hydroxide or perfluorinated aliphatic polyesters (e.g., commercially available as Fluorad FC 4430) in addition to a cyanoacrylate or a mixture of cyanoacrylates and/or further comonomers and a sulfonic acid as a stabilizer. These compounds serve to adapt the surface tensions of the building material, the bath and the element (already solidified preceding layers) to each other.

Furthermore, the building material can contain dyes in order to be able to produce coloured elements. The use of the three primary colours cyan, magenta and yellow enables arbitrarily coloured components, if the principle of multiple dosing devices is applied, which is used in two-dimensional colour ink jets.

The mechanical properties of the final elements can be affected by the presence of comonomers. If several different building materials are used in a multiple dosing device, elements having defined locally different mechanical properties (e.g. for stimulating certain functions) can be produced.

In addition to the base for neutralising the acidic stabilizers the aqueous bath fluid can also contain further additives. In this context, the following must be mentioned particularly: Surface-active substances (tensides, soaps, amphiphilic oligomers and polymers), water-soluble compounds and salts for adjusting the polarity, the ionic strength, the viscosity and the density of the bath fluid, and functional additives specific for the desired application, such as biochemically active substances.

Examples for such components are ethylene glycol, glycerine, poly(ethylene glycol), poly(propylene glycol), poly(ethylene glycol-co-propylene glycol), poly(hydroxyl ethyl acrylate), poly(ethyleneimine), polysaccharides such as starch, sugar derivatives, polypeptides such as gelatine, amino acids, salts such as sodium chloride, calcium chloride, surface-active substances such as the sodium salt of lauryl sulfonic acid, esters of the sodium salt of sulfosuccinic acid and further compounds for such applications known to the person skilled in the art.

For the formation of relatively large molded articles, a sufficiently large amount of base has to be contained in the bath. Preferred bases are alkaline and alkaline earth metal hydroxides as well as non-toxic amines such as phenyl glycine or basic amino acids or their derivatives. Sodium hydroxide is particularly preferred.

Alternatively or additionally, a sufficient capacity of base can be ensured by using buffering systems known in the art.

In addition to the base further initiators for anionic polymerisation, such as alkyl or aryl phosphines, particularly tributyl phosphine, can also be present.

If the viscosity of the bath is too low, waves are generated by lowering the building support, which can affect the geometry of the component. In order to avoid this, the viscosity of the bath must not be too low. On the other hand, the wetting of the element proceeds too slowly, when it is lowered, if the viscosity of the bath is too high. The viscosity of the bath fluid is adjusted in the best way by adding water-soluble substances, such as oligomers or polymers (PEG, but also biopolymers such as starch or gelatine), and sugar derivatives. A viscosity below 200 mPa·s is preferred, with a viscosity below 30 mPa·s being particularly preferred.

Also the density of the bath fluid plays an important role: It has to impart a buoyant force to the building material sufficient to enable the production of overhanging structures. On the other hand, the buoyant force must not deform the molded article when it is lowered. Also the density is adjusted by adding the components described above. The density preferably amounts to 0.95 to 1.15-times the density of the building material.

For applications in specific areas, which are not subject to any limitations concerning the handling, the toxicity and the disposal, such as the office area, and wherein the use by trained personnel is possible, also a bath made up of conventional organic solvents can be employed instead of the aqueous bath. In this case, the known initiators for anionic polymerisation such as organometallic compounds (e.g., butyl lithium, naphthalene sodium), alcoholates (e.g., potassium tert.butylate), phosphines (e.g., tributylphosphine) and others can be employed. Also the building material can contain solvents for such applications.

The general combination of a building material and a bath fluid being particularly suitable for the office area contains the following components:
Building material: anionically polymerisable cyanoacrylate or a mixture of cyanoacrylates in combination with lactide, maleic anhydride or glycidyl methacrylate as a comonomer and an alkyl sulfonic acid as a stabilizer.
Bath fluid: 0.05 to 5% aqueous solution of sodium hydroxide containing 0.1 to 10% of an ionic or non-ionic tenside and 1 to 30% of a polyethylene glycol having a molecular weight between 300 and 1,000.
Operation mode: When the droplets of the building material penetrate the bath fluid, the alkyl sulfonic acid is neutralized by sodium hydroxide and the polymerisation of the cyanoacrylate is initiated. The solubility of water in polycyanoacrylate is not sufficient to enable a larger amount of water to diffuse into the droplets of the building material. A high-molecular polymer is obtained thereby. The presence of the comonomer results in the formation of a material which is stable against hydrolysis.

A particularly preferred specific composition of the building material contains ethyl cyanoacrylate, glycidyl methacrylate and ethane sulfonic acid. The corresponding particularly preferred bath fluid consists of a 0.5 to 2% aqueous solution of sodium hydroxide containing 1 to 5% of a ionic or non-ionic tenside (e.g., a perfluorinated aliphatic polyester such as Fluorad FC 4430) and 5 to 20% PEG 400.

Further preferred alternative combinations of building material and bath fluid, which can be used according to the present invention, are as follows:

1. Building material: Radically polymerisable monomer (e.g., acrylates, methacrylates, styrene, styrene derivatives, vinyl esters, vinylidene compounds, dienes and the like as well as mixtures of these compounds or similar compounds) added with a component of a redox initiator system (preferably the reducing agent).
Bath fluid: Solution of the second component of the redox initiator system (preferably the oxidizing agent) in a non-solvent for the resulting polymer. The non-solvent can also be water.
Operation mode: When the droplets of the building material penetrate the bath fluid, the two components of the redox initiator system get into contact at the interface and react with each other to form radicals. The radicals initiate the polymerisation of the monomers, thereby curing the droplets. The polarity of the building material and the bath fluid and the solubility of the components of the redox initiator system, respectively, must be adapted to each other such that the radical formation due to the reaction of the initiator components is maintained long enough to completely polymerize the droplets. For this purpose, the bath and the building material can contain suitable additives.

2. Building material: Radically polymerisable monomer (such as acrylates, methacrylates, styrene, styrene derivatives, vinyl esters, vinylidene compounds, dienes and the like as well as mixtures of these compounds and other compounds), added with an initiator (e.g., a sterically hindered amine or phenol).
Bath fluid: Solution of a radical former (initiator) in a non-solvent for the resulting polymer. The non-solvent can also be water. The activation of the initiator is carried out by raising the temperature of the bath fluid to a temperature, at which the initiator slowly decomposes and forms radicals. Thereby, the initiator is consumed continuously, so that in the case of longer building periods initiator has to be added continuously to the bath. Alternatively, the activation of the initiator can be carried out by irradiation at a suitable wavelength (e.g., in the UV region). Also in this case the initiator is consumed continuously and has to be renewed.
Operation mode: The initiator contained in the building material avoids its premature polymerisation and, thus, provides storage stability and processability. Upon contact with the bath fluid the polymerisation is initiated by the radicals, which are produced by the decomposition of the initiator and are present in the bath at a low concentration. The decomposition rate of the initiator, the radical concentration, the formation time and the polymerisation rate have to be adapted to each other.

3. Like 1. or 2., however, macromonomers are additionally present in the building material in order to accelerate the increase in molecular weight and, thus, the development of the mechanical stability of the element. In this case, the viscosity of the building material has to be adapted to the requirements of the dosing system.

4. Like 1., 2., or 3., however, polyfunctional monomers are additionally present in the building material as crosslinking agents. For this purpose, e.g., divinyl benzene and its derivatives, bisacrylates or bismethacrylates as well as also the known trifunctional and tetrafunctional crosslinking agents and, particularly, suitable functionalized highly branched polymers, dendrimers and other dendritic compounds (e.g., those having terminal acrylate or methacrylate groups) can be employed.

5. Building material: Polyfunctional isocyanate or a mixture of isocyanate-containing compounds, optionally diluted with a solvent.
Bath fluid: Aqueous solution of a catalyst for nucleophilic addition to isocyanate groups, e.g., a non-toxic amine such as DBU or phenyl glycine.
Operation mode: Due to the contact of the building material with the aqueous bath some of the isocyanate groups hydrolyse to form amino groups, which subsequently react with further isocyanates, leading to the formation of polyureas, thereby curing the building material. The hydrolysis rate and the rate of the formation of the polyurea chains have to be adapted by the combination of suitable catalysts such that a complete curing of the droplets can occur, i.e., that the formation of the polymer does not proceed too rapidly.

6. Building material: Polyfunctional isocyanate or a mixture of isocyanate-containing compounds, optionally diluted with a solvent.
Bath fluid: Aqueous solution of a biopolymer (e.g., starch or gelatine) having nucleophilic functional groups.
Operation mode: Due to contact of the building material with the bath, the reaction of the isocyanate groups with nucleophilic side groups of the biopolymer results in a crosslinking. Thereby, a rigid polymer network, from which an element can be formed, is generated at those positions, at which the droplets of the building material penetrate the bath.

7. Building material: A monofunctional or polyfunctional epoxide or a mixture of different epoxides, optionally diluted with a solvent.
Bath fluid: Aqueous solution of polyfunctional amines or functionalized natural products such as starch or gelatine solutions having nucleophilic functionalities.
Operation mode: Penetrating the bath, the liquid building material reacts with the amines and the functionalized polymers, respectively, by opening the epoxide rings and, thus, forms a cross-linked polymer.

8. Building material: Alkoxysilanes or a mixture of compounds having one or more alkoxysilane groups.
Bath fluid: Water or aqueous solution.
Operation mode: Due to the contact of the droplets of the building material with the bath, a hydrolysis of the alkoxy silane groups occurs under elimination of alcohols. The intermediately formed silicic acid derivatives condensate under the elimination of water to form SiO₂ or organically modified SiO₂ in the case of alkyl or aryl substituted alkoxysilanes or to polysiloxanes depending on the substitution degree of the monomers and the composition of the monomer mixture, respectively. After curing the building materials can cover a very wide hardness range from rigid, brittle inorganic materials on the basis of SiO₂ to soft, elastomeric silicones. The size of the droplets, the polarity of the building material and the reaction rate have to be adapted such that, on the one hand, the outer layer is not completely hydrolysed and, on the other hand, a sufficient amount of water for the hydrolysis of the alkoxy groups is present in the interior of the droplets.

The application of subsequent layers of the building material can be carried out in different ways. On the one hand, it is possible to keep the respective top layer of the component under the surface of the bath. Thereby, the distance between the top layer and the surface of the bath can determine the thickness of the subsequent layer. The new layer of the building material is applied droplet by droplet in such a way that the individual droplets impinge through the fluid layer onto the preceding layer of the building material. Thereby, the polymerisation initiated by the bath already starts when the droplets pass through the fluid layer. In this case, the polymerisation rate and the viscosity of the building material as well as the viscosity and the density of the bath have to be adapted by the composition of the bath, the monomer mixture in the building material, the stabilizer in the building material and the initiator in the bath in such a way that the individual droplets still achieve a sufficient adhesion to each other and to the preceding layer when they impinge on the preceding layer of the building material. At the same it has to be ensured that the polymerisation does not proceed too slowly, because otherwise there is the danger that the individual droplets flow in a too high extent and that no defined edges can be formed.

On the other hand, the application of the respective subsequent layer of the building material can also be carried out in such a way that the element is initially completely immersed into the bath and is, subsequently, moved from below the surface exactly to the surface of the bath. Thereby, a fluid layer is formed on the element. The droplets are deposited thereon. The element is completely immersed into the bath after the application of each layer or after the application of several layers in order to give the droplets time sufficient to flow and to level unevenness, and, nevertheless, to achieve a uniform polymerisation of the building material. The number of layers being applied before the element is completely immersed (“deep dip”), has a substantial influence on the rate of the formation and on the quality of the layers, particularly, in those positions, which are formed freely over-hanging, having only the bath as support. Also the flowing of the building material into the bath can be avoided by completely immersing the element after the application of one or several layers. It is preferred to immerse the element after 1 to 5 layers, respectively.

A particularly preferred method according to the present invention is described in WO 01/26885, the relevant disclosure content of which is incorporated herein by reference. Further particularly preferred methods are the methods according to the present invention specified in claims 21 and 22. These methods refer to the use of combinations of building material and bath fluid according to the present invention. However, it is to be understood that the method according to the present invention can also be carried out with any other suitable combination.

The application of a building method as described in WO 01/78968 in the method according to the present invention is not possible, because according to the method described therein the opening port(s) of the dosing device must always be below the bath surface. In the case of using building materials as described in the present invention, this would result in the fact that the polymerisation already initiates at the outlet ports and that these outlet ports are thus plugged.

Under another aspect of the present invention, three-dimensional models are provided, which can be obtained by means of a method, preferably by the method described in WO 01/26885 or in claims 21 and 22, wherein the building material is deposited in a computer-controlled manner layer by layer on a support at specific positions in the form of individual droplets and is chemically hardened in these positions in the presence of the bath fluid, the outlet port of the dosing device being preferably in a position above the bath fluid.

Another aspect of the present invention relates to the use of the combination of the building material and the bath fluid according to the present invention for the production of three-dimensional models or elements and for the production of elements for the application in the field of medicine.

Another aspect of the present invention relates to a method for the production of three-dimensional elements, with the method described in WO 01/26885 or in claims 21 and 22 using the combination of the building material and bath fluid according to the present invention being preferably carried out.

In another aspect of the present invention, the three-dimensional models or elements produced using the combination of building material and bath fluid according to the present invention can have different colours and/or different mechanical properties due to the use of building materials and bath compositions, to which dyes have been added, or due to the use of different building materials and bath compositions leading to different mechanical properties.

Another aspect of the present invention relates to polycyanoacrylate copolymers having improved hydrolysis stability compared to polycyanoacrylates without comonomers, the polycyanoacrylate copolymers being obtainable by the reaction of the building material and the bath fluid.

A further aspect of the present invention relates to the post-treatment of the elements after being taken out of the bath fluid. For example, the elements can be washed with an aqueous solution or water. If desired, they can be dried afterwards. Also an improvement of the properties by fixation is possible (e.g., using water-based lacquers, hair spray or fixing sprays known in the field of artist supplies. Alternatively, a thermically or photochemically curing resin can be incorporated into the elements or the elements can be cured by heating or irradiating. The surfaces can be finished by grinding or varnishing.

### EXAMPLES

Concerning the following examples, it should be mentioned that not every building material (ink) can be combined with every bath fluid and every method. The examples indicate suitable combinations. At first, a general formulation with preferred variation ranges is specified. The percentages are based on the weight:

### General Example for Carrying Out the Invention

60 to 99% of a low-viscosity methyl, ethyl, or butyl cyanoacrylate serve as the basis for the building material. 0.5 to 5% of an organic carboxylic acid, sulfonic acid or phosphonic acid are added as a stabilizer. 0 to 20% 2-methoxyethyl cyanoacrylate, 0 to 15% lactide, 0-10% ε-caprolactone, 0-5% maleic anhydride and/or 0-5% of a suitable glycidyl ester or glycidyl ether are added as comonomers. Optionally 0-2% tenside and 0-2% dye are added.

The bath consists of an aqueous solution of 0.5 to 5% sodium hydroxide, 0 to 20% polyethylene glycol having a molecular weight within a range of 300 and 1000 and 0 to 3% of one or more tensides. Optionally the density is increased by adding 0 to 20% of a salt or a water-soluble organic substance.

The deposition can be carried out in such a way that the element is located just below the bath surface during the deposition. In this case, the element is lowered by one layer thickness after the deposition of each layer (in the following referred to as printing method 1).

Another possibility is to apply a new layer of the building material, while the surface of the element is 10 to 700 μm above the surface of the bath. However, in this case the element has to be lowered completely below the bath surface after the application of 1 to 5 layers and, subsequently, it has to be raised again in such a way that it is positioned 10 to 700 μm above the bath surface. Thereby, the bath fluid flows off after raising the element, so that the surface thereof is still slightly wet (in the following referred to as printing method 2).

After completing the printing procedure it is recommended to wash the element in a diluted citric acid solution for several minutes and to dry the element subsequently. A post-treatment using a commercially available clear lacquer is optionally advantageous in order to achieve more rigid and smoother surfaces.

### SPECIFIC EXAMPLES

### Example 1

Ethane sulfonic acid (5%), dodecyl dimethyl (3-sulfopropyl)ammonium hydroxide (2%) and methacrylic acid glycidyl ester (2%) are dissolved in a low-viscosity ethyl cyanoacrylate (91%).

A solution of polyethylene glycol (m.w.=400; 5%) and sodium lauryl sulfonate (1.0%) in 1% sodium hydroxide (an aqueous sodium hydroxide solution) are used as bath fluid.

The deposition is carried out as described in the general example as printing method 1. Since the formulation flows only slightly, fine structures can be imaged.

### Example 2

Ethane sulfonic acid (5%), dodecyl dimethyl (3-sulfopropyl)ammonium hydroxide (2%) and methacrylic acid glycidyl ester (2%) are dissolved in a low-viscosity ethyl cyanoacrylate (91%).

A solution of polyethylene glycol (m.w=400; 5%) and sodium lauryl sulfonate (1.0%) in 1% sodium hydroxide (an aqueous sodium hydroxide solution) is used as a bath fluid.

The deposition is carried out as described in the general example as printing method 2. After drying the element is sprayed with a commercially available clear lacquer. A smoother and more rigid surface can be obtained in that way. The surface stability is maintained over several weeks.

### Example 3

12% 2-methoxyethyl cyanoacrylate, 7% lactide and 1% formic acid are incorporated into a low-viscosity ethyl cyanoacrylate (80%). A solution of polyethylene glycol (m.w.=400; 5%) in 1% sodium hydroxide is used as a bath fluid. The deposition is carried out as described in the general example as printing method 2.

### Example 4

15% 2-methoxyethyl cyanoacrylate, 1% crystal violet and 1.5% vinyl phosphonic acid are incorporated into low-viscosity ethyl cyanoacrylate (82.5%). A solution of polyethylene glycol (m.w.=400; 5%) in 1% sodium hydroxide is used as a bath fluid. The deposition is carried out as described in the general example as printing method 2. Purple elements are obtained. The mechanical properties of the elements correspond to those made from uncoloured building material.

### Example 5

13% 2-methoxyethyl cyanoacrylate, 2% methacrylic acid glycidyl ester, 1% rhodamine B and 1.5% ethane sulfonic acid are blended in a low-viscosity ethylcyanoacrylate (82.5%). A solution of polyethylene glycol (m.w.=400; 5%) and the sodium salt of lauryl sulfonic acid (2%) in 1% sodium hydroxide are used as bath fluid. The deposition is carried out as described in the general example as printing method 2. The elements are pink. The mechanical properties of the elements correspond to those made from uncoloured building material.

### Example 6

2% methacrylic acid glycidyl ester, 1% butanediol diglycidyl ether and 3% ethane sulfonic acid are dissolved in a low-viscosity ethyl cyanoacrylate (94%). A solution of 5% polyethylene glycol (m.w.=400), 3.5% sodium lauryl sulfonate and 0.2% of a fluorinated aliphatic polyester (commercially available as Fluorad FC 4430) serves as a bath fluid. The deposition is carried out as described in the general example as printing method 2.

### Example 7

Improved Stability Imparted by Lactide

Polyethylcyanoacrylate is hydrolysed under the influence of strong bases. This degradation can already be noticed in a very early stage due to the change of colour of the polymers from yellow to blood-red. Furthermore, the degradation is associated with a weight loss. After stirring 500 mg pure polyethylcyanoacrylate in 10% sodium hydroxide for two hours a weight loss of 33% is observed.

If 85% by weight ethyl cyanoacrylate and 15% by weight dilactide are mixed, this mixture is polymerised under the same conditions as the pure ethyl cyanoacrylate described above and the polymer thus obtained is also treated for two hours with 10% sodium hydroxide, the weight loss only amounts to 26%.

### Example 8

The mechanical properties (toughness) of the polycyanoacrylate formed by the rapid prototyping method described can be improved by adding glycidyl compounds. The selection of the appropriate amount of the comonomer is essential, as can be seen from the following experiments:

Mixture 1: If 90% by weight ethyl cyanoacrylate, 3% by weight ethane sulfonic acid (stabilizer) and 7% by weight butanediol diglycidyl ether are mixed, the mixture solidifies within 24 hours.

Mixture 2: In contrast, if 95% by weight ethyl cyanoacrylate, 3% by weight ethane sulfonic acid (stabilizer) and 2% by weight butanediol diglycidyl ether are mixed, the resulting mixture can be stored for up to one year under the exclusion of light and humidity without a notable change in viscosity. After that the mixture can still be polymerised.

Both, mixture 1 and mixture 2 can be used to print elements by using the described method. The printability of mixture 1 is maintained only for about 1 hour, whereas mixture 2 can still be used for printing after one year without a loss in quality.

1. Combination of at least one building material and a bath fluid for a method for directly printing elements and models wherein
the building material contains at least one low-viscosity monomeric or oligomeric compound having a viscosity <200 mPa·s, which polymerises in contact with the bath fluid by the polymerisation of at least one component, and
the bath fluid consists of an aqueous solution containing an initiator, which initiates the polymerisation of at least one ingredient of the building material,
wherein the building material contains a cyanoacrylate represented by the general formula CH₂═C(CN)COOR, a mixture of cyanoacrylates or a mixture of one or more cyanoacrylate(s) with additional anionically polymerisable compounds, wherein the residue R comprises linear or branched, monosubstituted, polysubstituted or unsubstituted, aliphatic, cycloaliphatic or olefinic groups having 1 to 10 carbon atoms, monosubstituted, polysubstituted or unsubstituted aromatic groups having 6 to 18 carbon atoms and saturated, unsaturated and aromatic, 3- to 7-membered heterocyclic groups having one or more heteroatom(s) independently selected from N, S, O and P, which may be substituted by one or more substituents(s) selected from halogen (F, Cl, Br, I), hydroxyl, oxo, cyano, C₁₋₈-alkoxy, amino, mono or di(C₁₋₈)alkylamino, nitro, thiol and —S(O)n(C₁₋₈)-alkyl (n=0, 1, 2) and the bath fluid is a basic aqueous solution.

2. Combination according to claim 1, wherein the building material and/or the bath fluid contains further additives.

3. Combination according to claim 1, wherein the cyanoacrylate is methyl cyanoacrylate, ethyl cyanoacrylate, butyl cyanoacrylate or 2-methoxyethyl cyanoacrylate or a combination thereof.

4. Combination according to claim 1, wherein the additional anionically polymerisable compounds are selected from the group comprising cyclic esters, cyclic anhydrides and epoxides.

5. Combination according to claim 4, wherein the cyclic ester is 3,6-dimethyl-1,4-dioxane-2,5-dione, the cyclic anhydride is maleic anhydride and the epoxide is glycidyl methacrylate or butanediol diglycidyl ether.

6. Combination according to claim 1, wherein the basic aqueous solution is selected from the group of aqueous alkaline or alkaline earth metal hydroxide solutions or alkaline metal phosphate solutions, the group of aqueous amine solutions or the group of basic buffer solutions.

7. Combination according to claim 6, wherein the basic aqueous solution is selected from sodium hydroxide solutions (0.05 to 5%), sodium carbonate solutions (5 to 10%), aqueous solutions of lysine, guanidinium salts or phenyl glycine and phosphate buffer solutions.

8. Combination according to claim 1, wherein the building material contains an acidic stabilizer or a stabilizer leading to an acidic compound, when contacted with water.

9. Combination according to claim 8, wherein the stabilizer is selected from the group comprising sulfonic acids, carboxylic acids, organic phosphonic acids, sulfur dioxide and hydrogen chloride.

10. Combination according to claim 9, wherein the stabilizer is methane sulfonic acid, ethane sulfonic acid, toluene sulfonic acid, formic acid or vinyl phosphonic acid.

11. Combination according to claim 1, wherein the additives in the building material are selected from the group comprising surface-active compounds such as the sodium salt of lauryl sulfonic acid, dodecyl dimethyl (3-sulfopropyl)ammonium hydroxide and perfluorinated aliphatic polyesters.

12. Combination according to claim 1, wherein the additives in the bath are selected from the group comprising compounds for adjusting the viscosity and the polarity such as ethylene glycol, glycerine, poly(ethyleneglycol), poly(propylene glycol), poly(ethylene glycol-co-propylene glycol), poly(hydroxyethyl acrylate), poly(ethylene imine), polysaccharides such as starch, sugar derivatives, polypeptides such a gelatine, compounds for adjusting the surface tension, the density, the ionic strength and the pH such as amino acids, salts such as sodium chloride, calcium chloride, surface-active substances such as the sodium salts of lauryl sulfonic acid, esters of the sodium salt of sulfosuccinic acid, acrylic acid and poly(acrylic acid).

13. Combination according to claim 1, wherein the building material or the bath fluid contains additional substances to improve the mechanical properties of the polymers obtained.

14. Combination according to claim 13, wherein the building material contains at least one low-viscosity multifunctional compound having a viscosity <200 mPa·s as a crosslinking agent and the bath fluid contains oligomeric or polymeric compounds forming a branched-chain or crosslinked polymer by reacting with the building material.

15. Combination according to claim 1, wherein the building material or the bath fluid contains biochemically active substances to influence the properties of the polymers obtained.

16. Combination according to claim 13, wherein these substances also polymerize at least partially.

17. Combination according to claim 16, wherein these substances polymerize anionically.

18. Combination according to claim 1, wherein coloured elements can be obtained by adding dyes or pigments to the building material and/or to the bath fluid.

19. Combination according to claim 1, wherein the density of the bath fluid amounts to about 0.95 to 1.15 times the density of the building material, so that self-supporting structures can be produced due to the buoyant force, which are not destroyed by the lowering the element below the surface of the fluid.

20. A method for producing an element comprising:
(a) producing an element layer on a building support by selectively applying the building material by drop-on-demand technique
(b) filling recesses in the element layer by applying support fluid (bath fluid) having a density higher than that of the building material in such a way that the upper side of the element layer and the support fluid form an aligned surface,
(c) producing an element layer on the aligned surface of the preceding layer by selectively applying building material by means of a drop-on-demand technique, the building material being applied in the surface areas formed by support fluid in such a sequence that it is added laterally to the parts of the element layer already applied,
(d) producing further layers by repeating steps (b) and (c), each time, and
(e) separating the element from the support fluid.

21. A method for producing an element comprising:
(a) producing one or more element layers, preferably 1 to 5 layers, on a building support by selectively applying building material by drop-on-demand technique, the building support being positioned in a bath fluid in such a way that the surface of the building support is 10 to 700 μm above the surface of the bath fluid,
(b) lowering the building support, until the top layer of the element is completely lowered below the bath surface,
(c) raising the building support, until the top layer of the element is 10 to 700 μm above the surface of the bath fluid, with recesses in the top layer of the element being filled by the bath fluid,
(d) producing further element layers (preferably 1 to 5 layers) by selectively applying building material by means of a drop-on-demand technique, wherein the new element layer(s) can also exceed the area formed by the preceding layers and wherein the parts of the new layer(s) not applied on the preceding element layers are supported by the bath fluid,
(e) producing further layers by repeating the steps (b), (c), and (d), each time, and
(f) separating the element from the bath fluid.

22. A method for producing an element comprising:
(a) producing an element layer on a building support by selectively applying a building material by drop-on-demand technique, the building support being positioned in a bath fluid in such a way that the surface of the building support is positioned one layer thickness below the surface of the bath fluid,
(b) lowering the building support by one layer thickness,
(c) producing a further element layer by selectively applying building material by means of a drop-on-demand technique, wherein the new element layer(s) can also exceed the area formed by the preceding layers and wherein the parts of the new layer(s) not applied on the preceding element layers are supported by the bath fluid,
(d) producing further layers by repeating steps (b) and (c), each time, and
(e) separating the element from the bath fluid.

23. A method of claim 20, wherein elements having different mechanical properties are obtained by using different combinations of building material and bath fluid.

24. A method of claim 20, wherein elements having different colours are obtained by using dyes or pigments in the building material and/or in the bath fluid.

25. Element obtained by a method of claim 20.

26. Element produced from a combination of building material and bath fluid of claim 1.

27. Polymer having an improved hydrolysis stability, obtainable by reacting a cyanoacrylate represented by the general formula CH₂═C(CN)COOR, a mixture of cyanoacrylates or a mixture of one or more cyanoacrylate(s) with further anionically polymerisable compounds, wherein the residue R comprises linear or branched, monosubstituted or polysubstituted or unsubstituted aliphatic, cycloaliphatic or olefinic groups having 1 to 10 carbon atoms, monosubstituted or polysubstituted or unsubstituted aromatic groups having 6 to 18 carbon atoms and saturated, unsaturated and aromatic 3- to 7-membered heterocyclic groups having one or more heteroatom(s), independently selected from N, S, O and P, which may be substituted by one or more substituents(s) selected from halogen (F, Cl, Br, I), hydroxyl, oxo, cyano, C₁₋₈-alkoxy, amino, mono or di(C₁₋₈)alkylamino, nitro, thiol and —S(O)n(C₁₋₈)-alkyl (n=0, 1, 2), with at least one cyclic ester, cyclic anhydride and/or epoxide in the presence of an initiator for anionic polymerisation.

28. Polymer according to claim 27, wherein the cyanoacrylate is selected from the group comprising methyl cyanoacrylate, ethyl cyanoacrylate, butyl cyanoacrylate and 2-methoxyethyl cyanoacrylate or a combination thereof.

29. Polymer according to claim 27, wherein the cyclic ester is 3,6-dimethyl-1,4-dioxane-2,5-dione, the cyclic anhydride is maleic anhydride and the epoxide is glycidyl methacrylate or butanediol diglycidyl ether.

30-31. (canceled)
